(19) United States
(12) Patent Application Publication
(10) Pub. No.: US 2014/0187305 A1
(43) Pub. Date: Jul. 3, 2014

(54) Providing Games with Enhanced Prize Structures

(71) Applicant: Scientific Games International, Inc., Newark, DE (US)

(72) Inventor: Kenneth Earl Irwin, JR., Dawsonville, GA (US)

(73) Assignee: Scientific Games International, Inc., Newark, DE (US)

(21) Appl. No.: 14/108,999

(22) Filed: Dec. 17, 2013

Related U.S. Application Data
(60) Provisional application No. 61/746,667, filed on Dec. 28, 2012.

(51) Int. Cl. G07F 17/32

(52) U.S. Cl. CPC G07F 17/329
USPC 463/17

(57) ABSTRACT

Systems and methods for enhancing a prize structure of a game by using insurance to provide payment of highly valued prizes while securing the game entries such that the parties cooperating to form the entries are unable to locate winning entries in the completed entries.

### PRIORITY CLAIM

The present application claims priority to U.S. Provisional Application No. 61/746,667, filed Dec. 28, 2012.

### BACKGROUND

Lottery games have become a time-honored method of raising revenue for state and federal governments the world over. Traditional scratch-off and online games have evolved over decades, supplying increasing revenue year after year. However, after decades of growth, the sales curve associated with traditional games seems to be flattening out. Consequently, both lotteries and their game providers constantly search for new forms of gaming as well as ways to improve existing games to encourage greater participation.

Provision of games, especially games with a single large prize or several prizes of high value, help entice players to purchase game tickets and play the games. However, the gaming industry must constantly keep providing ever-increasing and ever-exciting gaming experiences in order to woo new players and maintain the loyalty of existing players.

One way to do so is to offer larger and larger prize amounts. However, doing so presents inherent difficulties. Foremost, although the games are typically odds-based with a low chance of winning the largest prizes, the prizes may nonetheless be won regardless of the number of players participating. The prizes then need to be awarded. In some situations, the prizes associated with a game, such as a lottery for instance, may cost more than was earned selling entries to the lottery or game. In this situation, a game provider is faced with not only having to provide the player the prize that was promised, but also having to overcome the financial difficulties associated with maintaining large cash reservoirs, and refilling same, in order to continue providing enticing games to players.

What is needed in the art are new ways of providing player excitement and encouraging game play, while also ensuring that awarding large prize payouts do not hamper or impede the game provider conducting the game. What is also needed is a way of providing such games in a secure, confidential manner such that those guaranteeing or providing the prize amounts are sufficiently satisfied that the game is secure.

### SUMMARY

Objects and advantages of the invention will be set forth in the following description, or may be obvious from the description, or may be learned through practice of the invention. It is intended that the invention include modifications and variations to the system and method embodiments described herein.

The present invention provides methods and systems for providing games, such as ticket-based games, with enhanced prize amounts while limiting the fiscal responsibility of the game provider. Also disclosed are ways of enhancing game play through manipulation of prize amounts while maintaining strict security regarding the game entries.

In accordance with aspects of the invention, a method is provided for enhancing the prize structure for a ticket-based lottery game administered by a game provider wherein a set number of game tickets are generated with a designed probability of winning and payout for the game. A particular embodiment includes generating a tiered prize structure for the set of game tickets that includes a first tier value for a top prize in the game and an alternate enhanced tier value for the top prize in the game. A subset of the game tickets are produced that are eligible for the enhanced tier value while the remaining game tickets are only eligible for the first tier value, with the subset of game tickets being undistinguishable from the remaining game tickets at the time of purchase of the game tickets. Arrangements are made with an insurer to provide insurance payment to the game provider in the event of payout by the game provider of the enhanced tier value, wherein the insurer receives a premium payment for the insurance. The insurer and the game provider participate in forming of game tickets and random generation of the subset of game tickets having the enhanced tier value.

In certain embodiments, the game is an instant-win game and the game tickets are instant-win tickets. In other embodiments, the game is conducted via an electronic device interfaced with the game provider and the game tickets are electronic tickets.

In a unique embodiment, the game tickets are produced with a game data file, and a randomization algorithm known to the game provider and the insurer is used to determine the subset of game tickets eligible for the enhanced tier value as a function of one or more variable seeds. The game provider and the insurer provide input for generation of the seeds that is maintained secret from the other respective party. At a time when neither of the game provider nor the insurer can change their respective seed input, the one or more seeds are provided to the game provider and insurer for independent verification of the algorithm outcome by the game provider and insurer.

In certain embodiments, the enhanced tier value is divided into sub-tier values, and the algorithm is also used to determine which of the sub-tier values applies to game tickets within the subset of game tickets.

The game provider and the insurer may input a respective seed into a computer system for use by the algorithm, with the respective seeds being unknown to the other party prior to exchange of the seeds between the game provider and the insurer. For example, the seeds may be exchanged in encrypted form between the game provider and the insurer, whereby the parties exchange encryption keys after the exchange of the encrypted seeds. In this manner, each of the game provider and insurer can independently verify the outcome of the algorithm with the other party's decrypted seed.

In a further embodiment, each of the game provider and the insurer provide a seed component to a separate event for determining a single combined seed that is input into the computer system for use by the algorithm, wherein the seed components are maintained secret from the other respective party. Each of the game provider and the insurer can verify that their respective seed input was used to determine the combined seed without knowing the other party's seed input.

In certain embodiments, the subset of game tickets include indicia that may be revealed to indicate that the respective game ticket is eligible for the enhanced tier value. This indicia may, for example, be covered by a scratch-off layer that is removed by the player after purchase of the paper or electronic game ticket. In a unique embodiment, the indicia provides for entry to a bonus game component wherein the value of the enhanced tier value is made known to the player of the game ticket.

Additional aspects of particular embodiments of the invention will be discussed below with reference to the appended figures.

### BRIEF DESCRIPTION OF THE DRAWINGS

A full and enabling disclosure, including the best mode thereof, to one of ordinary skill in the art, is set forth more particularly in the remainder of the specification, including reference to the accompanying Figures, in which:

FIG. 1 is a block diagram of a method for establishing a prize structure and using insurance coverage to provide enhanced prizes to modify same;

FIG. 2 illustrates a block diagram of a game provider and insurance provider establishing a prize structure with enhanced prizes.

FIG. 3 illustrates a system and process for multiple parties to contribute to the formation of a final seed used to generate a desired game.

FIG. 4 illustrates a method of forming a prize structure to modify an initial jackpot award via revealing enhancement indicia during game play.

FIG. 5 illustrates an embodiment where a player locates an enhancement indicia that provides access to a bonus game.

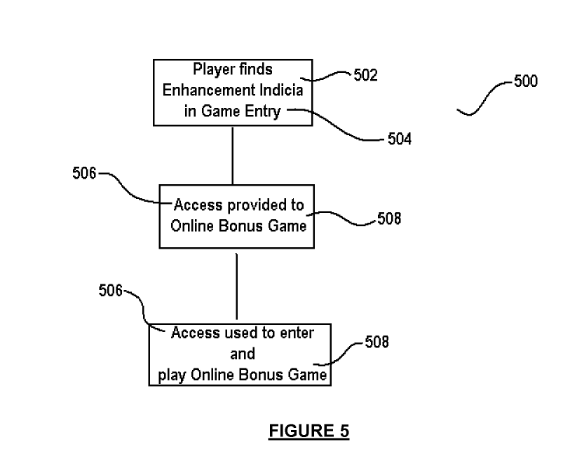

FIG. 6 illustrates one embodiment of a bonus game.

### DETAILED DESCRIPTION

Reference will now be made in detail to various embodiments of the presently disclosed subject matter, one or more examples of which are set forth below. Each embodiment is provided by way of explanation, not limitation, of the subject matter. In fact, it will be apparent to those skilled in the art that various modifications and variations may be made to the present disclosure without departing from the scope or spirit of the disclosure. For instance, features illustrated or described as part of one embodiment, may be used in another embodiment to yield a still further embodiment. Thus, it is intended that the present disclosure cover such modifications and variations as come within the scope of the appended claims and their equivalents.

In general, the present disclosure is directed to methods for enhancing game payouts while limiting game provider fiscal responsibility as well as providing game security.

Because of the need to provide exciting games and maintain player interest, games providers seek to not only provide new games but to also prolong the life of older games. One way to help achieve player engagement with a game is to make the prize levels very high in order to attract player attention and to encourage player involvement. This can benefit both a new game as well as be used to “retrofit” an existing or previously used game in order to build upon existing good will and to prolong the use of successful but possibly aged games. One way to provide increased prizes is to establish a prize structure for a game that includes high prize levels or high payouts. It should be understood that while the terms “prize” and “payout” are not limited to solely monetary prizes but may include other prizes including cars, electronics, jewels, precious metals, or any other item of value to the player. Table 1 illustrates one possible prize structure that may be associated with a game:

TABLE 1

| Payoff | Probability | Expected Value (EV) | Game Provider Cost |
|---|---|---|---|
| $720,000 | 0.001943 | $1,399.30 | $3,598.25 |
| $60,000 | 0.008245 | $494.69 | $989.37 |
| $30,000 | 0.07002 | $2,100.59 | $4,201.19 |
| $10,000 | 0.919792 | $9,197.92 | $10,177.71 |

| | |
|---|---|
| Total: | $18,806.52 |

As Table 1 illustrates one possible prize structure a game provider could establish may be based on the probabilities of a player winning an award amount where the game provider contracts for, or purchases, insurance to cover the payoff amount. It should be understood that while Table 1 reflects one possible prize structure, the prize structure is not so limited. Differing prize amounts, differing numbers of prizes, ranges of prizes, as well as different expected values and game provider costs may all be varied to create a prize structure suitable for the game provider.

Allowing a game provider to contract for insurance coverage to cover large prize amounts is similar to the “Hole in One” coverage that charities and various groups use to cover offering large prizes such as new cars or, for example, a $1 million dollar cash award, at events such as golf tournaments or charity events. At essence, the charity, would, for a fraction of the price of the award, obtain insurance coverage to insure that the prize can be paid or provided, if a player makes a hole in one or otherwise satisfies criteria for winning.

For purposes of this disclosure, a game provider can take advantage of insurance coverage by using the amount that might have been put toward a grand prize, for purposes of example only and not intended to be limiting, e.g. $20.000, to buy insurance. While insurance is disclosed as one way of funding the prizes, other funding, surety or guarantee means as known to those of skill in the art may be used to fund and ensure payment of the prizes disclosed herein, whether monetary or otherwise. Whereas previously the game provider would need to maintain the funds in escrow to pay the winner of the $20,000 prize, the funds could now be used to purchase insurance coverage of higher prize amounts. Thus, instead of simply providing one $20,000 prize, the funds could be used to create a new prize structure offering significantly higher prize amounts as shown in Table 1. Moreover, such insurance coverage may even be purchased at a lower price than the amount the game provider would have initially offered as a grand prize. For instance, if a game initially offered a $20,000 prize, its prize structure could be modified through the use of insurance coverage to provide the $720,000, $60,000, $30,000 and $10,000 prize amounts. Indeed, as Table 1 further displays, the cost for insuring these amounts may total less than the initial $20,000 grand prize. Thus, not only can the game provider entice players with larger prize amounts, but doing so may actually cost less to the game provider than simply providing the original grand prize amount.

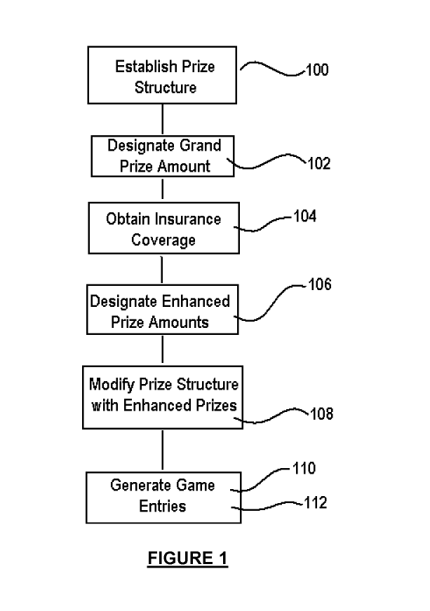

Indeed, in one embodiment a game provider may “juice” or “ramp up” an existing prize structure. For instance, as FIG. 1 illustrates, a game provider or other entity may establish a prize structure 100 with a grand prize amount 102. It should be understood that establishing a prize structure 100 may occur via the game provider acting alone, another party acting alone, the game provider acting in conjunction with another party, or via a combination of the game provider acting with other parties. The game provider may then obtain insurance coverage 104 and designate enhanced prize amounts 106. Possible insurance providers include entities such as SCA Promotions, Zurich North America, Nationwide, etc. The enhanced prize amounts 106, such as the examples shown by Table 1, may then be used to modify the prize structure 108 such that the enhanced prize amounts 106 are entered into or modify prize structure 100. Thus, the prize structure 100 may be “juiced” or upgraded with enhanced prize amounts 108 as opposed to the originally planned grand prize amount 102. Game entries 110 can then be created 112 using the enhanced prizes 108 as prizes a player could potentially win. Game entries 110 may be printed tickets or electronic entries such as entries into an online or Internet based game. After the game entries are formed, they may then be distributed for players to obtain the entries and play the game to attempt to earn the higher prizes. While the steps of FIG. 1 are shown in a particular order, the specification is not so limited and the steps may be performed in various orders, such as, for purposes of example only, insurance being obtained first, last or intermediate to the disclosed steps.

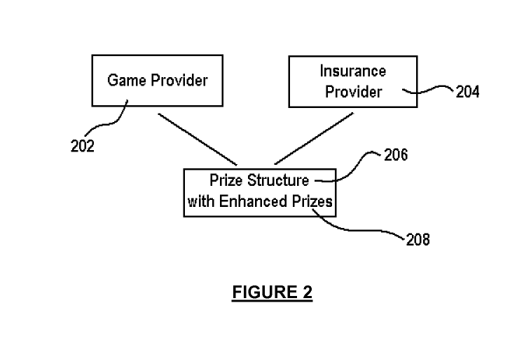

In a further embodiment, a game provider may work in conjunction with another party, such as an insurance provider, to mutually create the game entries as shown in FIG. 2. Such an arrangement allows game provider 202 and insurance provider 204 to establish a prize structure 206, which game provider 202 believes will attract additional players through the use of enhanced prizes 208 of sufficiently high value that insurance provider 204 agrees to insure. This allows game provider 202 to not only obtain insurance but to do so in such a way that insurance provider 204 agrees to and possibly assists with establishing prize structure 206. This arrangement significantly enhances the ability of game provider 202 to obtain the assistance of insurance provider 204 to establish a high paying game with highly valued enhanced prizes 208 that are covered by insurance provided by insurance provider 204. In addition, game provider 202 may also allow insurance provider 204, or any other cooperating party or parties, to assist in forming the game entries used to conduct the game.

In one embodiment, game provider 202 may cooperate with insurance provider 204 to create the game entries used to play the game with the agreed to prize structure 206 using enhanced prizes 208. This may be accomplished, for example, via using heightened security to generate the game entries. For example, the parties may each provide a “key” or “seed” to help generate the entries. The term ‘key’ or ‘seed’ in this application may mean a single cryptographic key used for encryption and decryption; or it may mean a file of numerical values used to seed a Random Number Generator or RNG. An RNG is a computational or physical device designed to generate a sequence of numbers that lack any pattern, i.e., appear random, and such devices are well known to those of skill in the art.

Suitable encryption protocols include RSA, One-Time-Pad, Transport Layer Security, Internet Key Exchange, IPsec, Kerberos, Point to Point Protocol, Cramer-Shoup cryptosystem, EIGamal encryption, DSA, MQV, FHMQV, IKE, elliptic curve techniques, such as Elliptic curve Diffie-Hellman, STS, Diffie-Hellman STS and Diffie-Hellman. Another possible solution is the PROOFPOINT DOUBLEBLIND Key Architecture offered by Proofpoint, Inc., 892 Ross Drive, Sunnyvale, Calif. 94089.

A cryptographic key is a piece of information (a parameter) that determines the functional output of a cryptographic algorithm or cipher. Without a key, the algorithm would produce no useful result. In encryption, a key specifies the particular transformation of plaintext into ciphertext, or vice versa during decryption. A key exchange or multiple key combination method allows two parties that have no prior knowledge of each other to jointly establish a shared secret key over an insecure communications channel, i.e., a protocol where a malignant eavesdropper can observe all key negotiations between at least two parties and still remain unable to deduce the final key.

In a particular embodiment of the disclosure, a game generation seed number may be formed from multiple seed numbers from multiple and differing parties such that no one party has the ability to create the final seed number without the other parties' consent or knowledge. Since the final seed number would be required by the software that governs the distribution of prizes within a game and is therefore required to produce valid game data, no one entity would have enough information to determine the location of a winning prize or high prize tier within the game. This is desirable because it creates an environment of transparency such that all parties must agree on the terms that result in the formation of the final seed number from the individual seed number fragments in order to produce a game. This would be especially useful with respect to this disclosure as a game provider can not only enlist the aid of an insurer by insuring the prize amounts but could further have the insurance provider “buy in” by allowing them to provide a seed from which the game entries are created. Thus, the insurance carrier is further protected because not only have they agreed to the prize structure that will provide high value prizes, but they also contribute to and help control generation of the game entries.

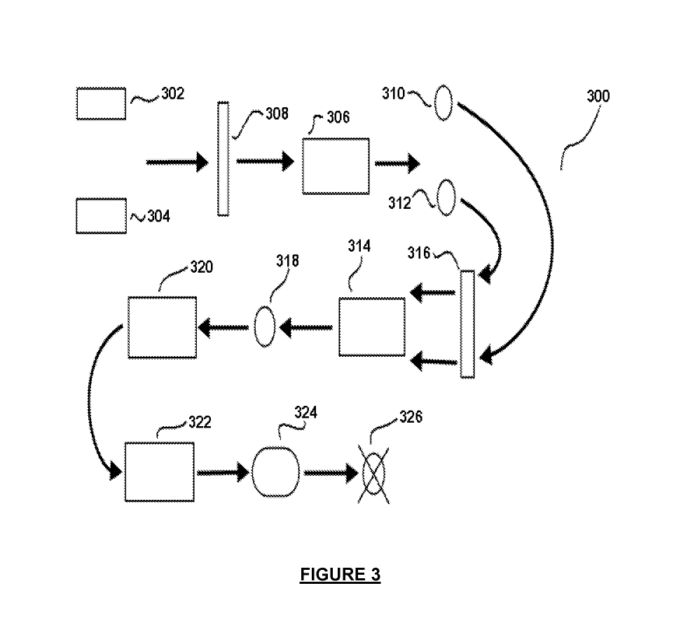

Referring to FIG. 3, in one preferred system embodiment 300, multiple parties 302 and 304 access a portal, such as web portal 306 or other comparable platform as known to those of skill in the art. The number of parties accessing the portal is shown as two but more or less parties are also herein envisioned and the disclosure should not be considered limited to just two parties. The portal may be protected by a firewall 308 to provide security for web portal 306 to prevent unauthorized access to system software or data. The web portal 306 may be configured to create and encrypt seeds for each of the parties with access to web portal 306. The result of parties 302 and 304 interfacing with web portal 306 is a series of seed sets 310 and 312 that are known only to the respective creators of the seeds (parties 302 and 304, respectively).

These parties may supply information used to create the seeds as required by the seed generation process. For purposes of example only, the seeds may be established by the state of a computer system, such as the web portal 306, a cryptographically secure pseudorandom number generator, a hash algorithm, from a hardware random number generator, or via other means as known to those skilled in the art. In one embodiment, the seeds could be hashed with a public result over which neither party has any control, for instance, the listing of gold prices on a particular day or a result such as a PowerBall drawing. Indeed, the parties could further agree that the agreed to public result could be further manipulated by an algorithm before being used to create the game entries.

After seed sets 310 and 312 are generated, they may be transferred to a location such as a secured server 314, or other suitable device as known to those of skill in the art. This transfer may also require the seed sets 310 and 312 pass through a second firewall 316, although this is optional and not required. At the secured server 314, the seed sets 310 and 312 may be combined to form a final seed 318. The seed sets 310 and 312 may be combined via processes known to those of skill in the art such as by using algorithms. The algorithm used to combine the seeds may be a custom and proprietary algorithm developed specifically for the purpose of combining multiple seeds (or integers) into a single, final seed number. After final seed 318 has been generated, it is made available to a specialized seed server 320, or other suitable device as known to those of skill in the art, and stored therein. Final seed 318 may reside either at the secured server 314 or seed server 320, depending on the desired security scenario.

Further, the secured server 314 and seed server 320 may either or both be administered by a trusted third party to ensure confidentiality of the information contained in the respective servers. Or the servers may be secured by the game provider. Once it is decided to generate a game, final seed 318 is provided to game engine 322. The final seed 318 may either be transmitted directly from the seed server 320 or seed server 320 may request the final seed 318 from the secured server 314. Game engine 322 may generate a data file 324 from the final seed 318 that contains the game play information for the desired game. Game data file 324 may be generated by the game engine 322 from final seed 318 via methods known to those of skill in the art. Typically this would be a custom application developed and used by the game provider; however it is possible that the game software and game engine would be commercially available software. In either case, an RNG executed by game software running within a game engine requires the use of a final seed to control the distribution of winning and losing tickets within the game.

In one aspect of a preferred embodiment, once the tickets have been formed and shipped, final seed 318 may be destroyed or “dissolved” such that only the seed sets 310 and 312 remain in the system and these, too, may be dissolved. Alternatively, the final seed 318 may be securely stored within systems maintained by the game provider or within systems maintained by a trusted third party, or there may be other methods that would be readily apparent to those of skill in the art. Thus, to recreate the final seed 318, the seed sets 310 and 312, which may be either in the possession of the parties that created the respective seed or one or more trusted third parties, are all needed to reform the final seed 318. In situations where final seed 318 is not destroyed or deactivated, then the final seed may be available to the game provider, or other party contributing to the generation of the final seed 318, under the supervision of a trusted third party or via another process, which can either manipulate the final seed 318, as known to those of skill in the art, or via a physical process that maintains limited access to the final seed 318 or any deactivated seed, such that access to the final seed 318 is made known to the parties contributing to formation of the final seed 318. This assures transparency in that all parties are aware that their respective seed fragments were used to reform the final seed 318 in the event that the final seed must be recreated.

Thus, the final seed 318 is created from input from parties 302 and 304 via seed sets 310 and 312. Because the final seed 318 derives from seed sets 310 and 312, no party can recreate final seed 318 without the cooperation of the other party or parties to provide the remaining seed numbers necessary to create the final seed 318. Say, for instance, to reconstruct data relating to stolen or missing tickets from the game, one needs the final seed in order to recreate the game data. Based on the description herein, the reconstruction is only possible with the assistance, knowledge or permission of the creators of the seed sets 310 and 312.

A game provider, insurance carrier, lottery administrator and other third parties may serve as parties 302 and 304, or additional parties may contribute seeds to the game generation process. Indeed, in some embodiments, a single party may provide more than one set of seeds for use in the creating the final seed 318. Further, a party may receive the seed sets of other parties or may transmit its seed set to a receiving party. Further, the party receiving the seed sets may or may not be the party that manipulates or combines the seed sets to arrive at a final seed set. For instance, in one embodiment, the game provider may receive the seeds from the other parties. These can be combined via various mathematical techniques, as known to those of skill in the art, to arrive at the final seed. Thus, at least one of the seed fragments would be used to produce the final seed. From the moment the final seed is formed it is available to the game provider to create data or otherwise manufacture the game. The final seed is “active” during the data generation process and manufacturing process.

In an alternative embodiment, it may be possible to “reform” the final seed at each step of the manufacturing process and deactivate or destroy the final seed once it has been used as needed. In the preferred embodiment, the seed is ‘deactivated’ once the tickets leave the manufacturing center, or are made available for use in an electronic or internet based gaming system, such that any subsequent activity involving the use of the final seed requires the assistance, knowledge or permission of the original seed set creators. This may be a process in which the original creators must give their explicit permission or it may be a process in which the parties are simply made aware that the final seed has been accessed or used. Further, the final seed—in its deactivated state—may be stored or otherwise maintained by a single or multiple servers that are administered by the game provider or trusted third party. Thus, reactivation or recombination of the seeds will be clearly transparent to all parties and will produce the same final key, which in turn can be used to reform the previously created game data and results.

By securing the seed, it becomes much more difficult for someone to illicitly use the game generation software to produce or reproduce the data since the seed controls the process that produces the mixture of winners and losers. Without access to the final seed for a particular game, the software cannot produce the correct and actual mixture. The present disclosure may help to secure the confidentiality of the seeds used by the game software. Further, the integrity of the game is based on using the one and only seed (or set of seeds) used to produce the game data.

In a particular embodiment of the disclosure, a final game generation seed number is formed from multiple seed numbers from multiple and differing parties such that no one party has the ability to create the final seed number without the other parties' consent or knowledge. Since the final seed number is required by the software that governs the distribution of prizes within a game and is therefore required to produce valid game data, no one entity would have enough information to determine the location of a winning prize or prize tier within the game. This is desirable because it creates an environment of transparency such that all parties must agree on the terms that result in the formation of the final seed from the individual seed fragments in order to produce a game. There are multiple ways that agreeing parties can create seed numbers or sets of seed numbers such that only the creator of the seed numbers or sets are the only ones who know the true value of the seed numbers. Those of skill in the art are aware of commercially available software or hardware devices to achieve this; or those of skill would have the means to develop custom software or modify commercially available software that would be capable of securely forming seed sets.

In one embodiment, a method is disclosed that will use the multiple and individual seed sets to form a single or final seed number that can be used by an RNG. One method, but those of skill in the art would recognize that there are many methods, would be to use the individual seed numbers as input to an algorithm that returns a single seed number. The single seed number would then be known as the final seed number and would be used by the game RNG to produce the required unbiased and unpredictable sequence of numbers used in turn to produce the unbiased and unpredictable sequence of winning and losing tickets. For example, the multiple seed numbers produced by the individual parties could be simply added together; or could be encrypted; or any number of mathematical operations could be used to take multiple inputs and produce a single output in a manner that can be securely conducted and in a manner that is repeatable.

With respect to this disclosure, the game provider and insurance provider, or other parties depending on how many are involved, may know the specific prize structure, for insurance purposes alone, as well as the prizes associated with any prize tiers associated with the prize structure. However, none will know the location of the prizes or the associated prize tiers with respect to the tickets or entries with which they are associated. Thus, not only does an insurer gain confidence from knowing the amounts insured, but the insurer may help create the game entries through providing a seed, and the security of the game entries is such that not even those entities creating the entries know the prize tier associated with a ticket, let alone if a ticket may provide a prize from within the prize tier.

The prize tiers associated with the prize structure may vary as shown in Table 1. In a further embodiment, the prize tiers have a minimum threshold and a maximum threshold. For instance, and for purposes of example only, the minimum threshold may be zero and the maximum threshold may be a value of, e.g., $720,000, $1,000,000, $10,000,000, $40,000,000, etc. However, the disclosure is not so limited and values between the minimum and maximum threshold, as capable of being determined by game providers or others skilled in the art, are included in this disclosure. Further, some tickets may include a prize tier wherein the minimum number is above zero. Thus, if a ticket having a tier with a minimum prize tier value above zero is a winning ticket and the player wins the game, a prize is guaranteed via this type of prize tier.

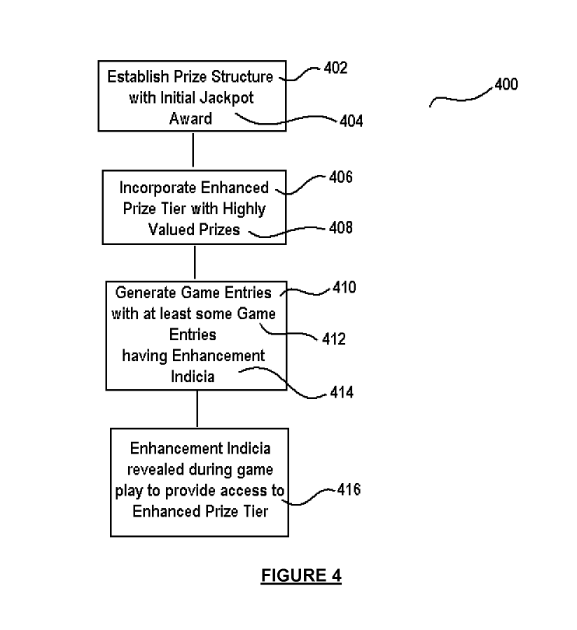

In a further embodiment 400, as shown by FIG. 4, a prize structure with a variable prize tier may be used to “juice” or enhance a game with a disclosed initial jackpot. For example, a Prize Structure 402 may be established with an initial jackpot award 404 of, for purposes of example only and not intended to be limiting, $20,000. Meanwhile, an enhanced prize tier system 406 with highly valued prizes 408 greater in value than the initial jackpot award 404, such as for purposes of example only, $50,000, $100,000, $500,000 and $1,000,000, may be incorporated into the tickets or game entries as disclosed herein. However, the disclosure herein is not limited to these values. Values below, between, or exceeding these amounts are also capable of being employed. This also includes ranges of these amounts. The highly valued prizes 408 may be funded through insurance or any other such surety or guarantee means as known to those of skill in the art. In order to provide a player access to the enhanced prize tier 406 and highly valued prizes 408, at least some of the game entries 410 are generated 412 such that particular entries contain a probability or enhancement Indicia 414. The game entries may also be generated securely via multiple party input as described herein. During game play 416, revealing enhancement indicia 414 on a ticket or entry 410 changes the possible maximum prize of the entry from the initial jackpot award 404 to a possible maximum prize as dictated by the enhanced prize tier 406 associated with the ticket and the highly valued prizes 408 associated with the prize tier 406, if any.

Thus, a player may be enticed to play the game by seeing the value of the initial jackpot 404 but understanding that finding an enhancement indicia 414 would propel the ticket or entry 410 into an enhanced prize tier 406 with highly valued prizes worth more than the initial jackpot amount 404. Further, the number of prize tiers 406 is not limiting to this disclosure and may be as many or as few prize tiers as desired. Additionally, the prize tiers 406 may differ such that separate tickets may provide access to separate prize tiers 406. Moreover, while ticket may indicate the same prize tier 406, the differing prize tiers 406 may provide the same or different highly value prizes 408. For instance, a prize tier 406 may include a single highly valued prize 408 or multiple, different highly valued prizes 408, wherein a winning ticket will disclose the highly valued prize 408 won from within the prize tier 406. Further, tickets or entries with the same prize tier 406 indicated may provide different highly valued prizes 408. Indeed, one ticket could provide a single highly valued prize 408 and another ticket with the same prize tier 406 could provide a different highly valued prize 408, or could provide multiple, different highly valued prizes 408 as compared to the first prize tier 406. In an alternative embodiment, the probability or enhancement indicia 414 may result in the ticket or entry 410 providing access to a prize tier 406 wherein the maximum highly valued prize 408, whether a single prize or multiple prizes, included in the prize tier 406 is less than the initial jackpot award 404.

In a further embodiment 500, revealing a probability or enhancement indicia 502 in a game entry 504 provides the player with an access 506 to a bonus game 508. The access 506 provides the player entry to the bonus game and allows play of the bonus game 508. Access 506 may be any access as known to those of skill in the art including numeric, alphabetic, alphanumeric, symbolic, or otherwise. In one embodiment access 506 may comprise an entry code that when entered into a specified website or portal allows the player to play the bonus game 508. In a further embodiment, bonus game 508 may be a continuation of the game played on game entry 504 or bonus game 508 may be a separate game altogether. In a preferred embodiment, game entry 504 is a ticket based game and bonus game 508 is an online or Internet based game. In a further embodiment, bonus game 508 may be used to display the prize tier and possible prizes associated with game entry 504.

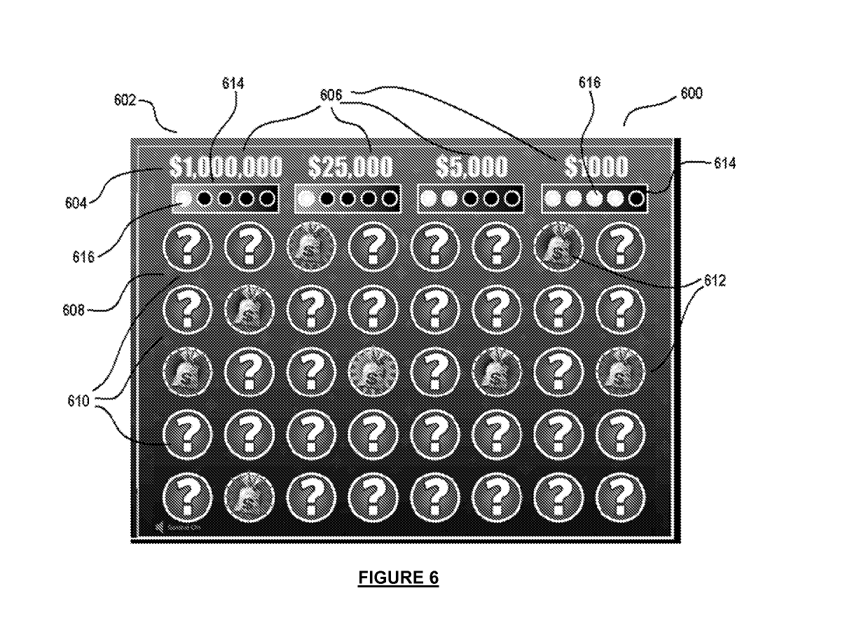

FIG. 6 illustrates one embodiment 600 of a bonus game 602 that may be provided by a player revealing a probability or enhancement indicia 502 (not shown) that provides access 506 (not shown) to bonus game 602. As FIG. 6 illustrates, bonus game 602 shows prize tier 604 and possible prizes 606, which for purposes of example and illustration only, are prizes for $1,000, $5,000, $25,000 and $1,000,000. As FIG. 6 shows, in one embodiment bonus game 602 may comprise a selection game 608 wherein a player selects indicia 610 in order to reveal prize indicators 612 and attempts to reveal sufficient prize indictors 612 in order to completely fill a prize bar 614 associated with one of the prizes 606. As FIG. 6 shows, eight prize indicators 612 have been selected illuminating one prize beacon 616 in the $1,000,000 and $25,000 prize bars 614, two prize beacons 616 in the $5,000 prize bar, and four prize beacons 616 in the $1,000 prize bar 614. In a further embodiment, the appearance of prize indicators 612 may be weighted such that the chances of a player winning a higher prize amount are lower than those of a player winning a low prize amount or no prize amount at all. While a selection game is illustrated, this disclosure is not so limited and bonus game 602 may be any game as known to those of skill in the art and may be used in association with prize tier 604 to illustrate the potential prizes 606 that a player may win if successful at bonus game 602.

In a further embodiment, the outcomes of game entry 504 and bonus games 508 and 602 may be predetermined. In a further embodiment, game entry 504 may be a game of chance while bonus games 508 and 602 may be games of skill, all three may be games of chance, all three may be games of skill, or any variation thereof. In a still further embodiment, Game entry 504 and bonus games 508 and 602 may also be mixed games of skill or chance.

The various control functionalities of the present method embodiments are computer-implemented by any suitably configured computer server, system or network that interfaces with the game provider and insurer, and with any other party that may participate in the functionalities. For example, the game provider may utilize a central host computer system in the conduct of a lottery game in a given jurisdiction. This host computer system may also be in communication with a host system maintained by the insurer for exchange of data necessary to carry out the present control methods. In a particular embodiment, either of the game provider host computer or the insurer host computer may function as the computer system that stores the algorithm and receives the seed(s) or seed inputs from the respective parties, with the algorithm outcome being transmitted to the other party's computer system. In an alternate embodiment, a third party computer system (independent of the game provider and insurer) may be used to store the algorithm, receive the seed data from the game provider and insurer, and compute the algorithm outcome, which is then transmitted to the respective computer systems of the game provider and insurer. It should be readily appreciated that the computer-implemented functionalities may be widely configured within the scope and spirit of the invention, and that the invention is not limited to any particular hardware or software configuration.

As used herein the singular forms “a,” “an,” and “the” include plural referents. The term “combination” is inclusive of blends, mixtures, alloys, reaction products, and the like. Unless defined otherwise, technical and scientific terms used herein have the same meaning as is commonly understood by one of skill. Compounds are described using standard nomenclature. The term “and a combination thereof” is inclusive of a combination of one or more of the named components, optionally with one or more other components not specifically named that have essentially the same function.

While the subject matter has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present disclosure should be assessed as that of the appended claims and any equivalents thereto.

What is claimed is:

1. A method of enhancing the prize structure for a ticket-based lottery game administered by a game provider wherein a set number of game tickets are generated with a designed probability of winning and payout for the game, comprising:
generating a tiered prize structure for the set of game tickets that includes a first tier value for a top prize in the game and an alternate enhanced tier value for the top prize in the game;
forming a subset of the game tickets that are eligible for the enhanced tier value while the remaining game tickets are only eligible for the first tier value, the subset of game tickets being undistinguishable from the remaining tickets at the time of purchase of the game tickets;
arranging with an insurer to provide insurance payment to the game provider in the event of payout by the game provider of the enhanced tier value, wherein the insurer receives a premium payment for the insurance; and
wherein the insurer and the game provider participate in forming of the game tickets and random generation of the subset of game tickets having the enhanced tier value.

2. The method as in claim 1, wherein the game is an instant-win game and the game tickets are instant-win tickets.

3. The method as in claim 2, wherein the game is conducted via an electronic device interfaced with the game provider and the game tickets are electronic tickets.

4. The method as in claim 2, wherein the game is conducted via paper game tickets.

5. The method as in claim 1, wherein the game tickets are produced with a game data file, and wherein a randomization algorithm known to the game provider and the insurer is used to determine the subset of game tickets eligible for the enhanced tier value as a function of one or more variable seeds, the game provider and the insurer providing input for generation of the seeds that is maintained secret from the other respective party.

6. The method as in claim 5, wherein at a time when neither of the game provider or the insurer can change their respective seed input, the one or more seeds are provided to the game provider and insurer for independent verification of the algorithm outcome by the game provider and insurer.

7. The method as in claim 5, wherein the enhanced tier value is divided into sub-tier values, the algorithm also used to determine which of the sub-tier values applies to game tickets within the subset of game tickets.

8. The method as in claim 5, wherein each of the game provider and the insurer input a respective seed into a computer system for use by the algorithm, the respective seeds being unknown to the other party prior to exchange of the seeds between the game provider and the insurer.

9. The method as in claim 8, wherein the seeds are exchanged in encrypted form between the game provider and the insurer, and the game provider and the insurer exchange encryption keys after the exchange of the encrypted seeds.

10. The method as in claim 9, wherein each of the game provider and insurer can independently verify the outcome of the algorithm with the other party's decrypted seed.

11. The method as in claim 5 wherein each of the game provider and the insurer provide a seed component to a separate event for determining a single combined seed that is input into the computer system for use by the algorithm, wherein the seed components are maintained secret from the other respective party.

12. The method as in claim 11, wherein each of the game provider and the insurer verify that their respective seed input was used to determine the combined seed without knowing the other party's seed input.

13. The method as in claim 5, wherein the algorithm is a randomized encryption function algorithm.

14. The method as in claim 13, wherein the algorithm is a one-time-pad encryption function algorithm.

15. The method as in claim 5, wherein the seed for the algorithm is derived from a public domain source that is beyond the control of either of the game provider or the insurer.

16. The method as in claim 1, wherein the subset of game tickets include indicia that may be revealed to indicate that the respective game ticket is eligible for the enhanced tier value.

17. The method as in claim 16, wherein the indicia provides for entry to a bonus game component wherein the value of the enhanced tier value is made known to the player of the game ticket.

18. The method as in claim 17, wherein the game ticket is a printed ticket and the bonus game is an online game.

19. The method as in claim 17, wherein the game ticket is an electronic ticket and the bonus game is an online game.
